(19) United States
(12) Patent Application Publication
(10) Pub. No.: US 2026/0133887 A1
(43) Pub. Date: May 14, 2026

(54) METHOD AND SYSTEM FOR FEATURE SELECTION TO PREDICT APPLICATION PERFORMANCE

(71) Applicant: Telefonaktiebolaget LM Ericsson (publ), Stockholm (SE)

(72) Inventors: Chunyan FU, Pointe-Claire (CA); Behshid SHAYESTEH, Montreal (CA); Amin EBRAHIMZADEH, LaSalle (CA); Roch GLITHO, Saint Laurent (CA)

(73) Assignee: Telefonaktiebolaget LM Ericsson (publ), Stockholm (SE)

(21) Appl. No.: 19/118,457

(22) PCT Filed: Oct. 7, 2022
(86) PCT No.: PCT/IB2022/059629

§ 371 Date: Apr. 4, 2025

(51) Int. Cl. G06F 11/34

(52) U.S. Cl. CPC G06F 11/3466

(57) ABSTRACT

Embodiments select features for performance prediction. In one embodiment, a method comprises: receiving a request to select features to predict a performance issue of an application, the request indicating a set of key performance indicators (KPIs) for the application and data of performance metrics; selecting a first set of features, a feature being selected to the first set of features based on correlation between the feature and the set of KPIs; selecting a second set of features from the first set of features to predict the performance issue of the application, a feature being selected to the second set of features based on a causal relationship between the feature and the set of KPIs; and causing prediction of the performance issue of the application based on the second set of features and corresponding time lags between the second set of features and the set of KPIs.

### TECHNICAL FIELD

Embodiments of the invention relate to the field of performance management; and more specifically, to select features to predict application performance.

### BACKGROUND ART

Mission critical fifth generation (5G) applications are expected to be highly reliable, always available with a guaranteed quality of service (QoS). Applications deployed in 5G cloud systems may suffer from performance degradations (and/or service interruptions), caused by various reasons such as infrastructure- and resource provisioning-related issues. Preventive management of such issues is thus critical for maintaining the application availability and performance.

Yet predicting performance degradation (and/or service interruptions, where the two terms are used interchangeably herein) at the application level is more challenging than predicting an infrastructure fault for at least the following two reasons:

(1) The causes of an application performance degradation can be more complicated, mainly because the degradation can be triggered in various ways, such as a server hardware problem, lack of Virtual Machine (VM) resources, a container down, a load balancer misconfiguration, a network congestion, or a cloud management system scheduling problem. When building an artificial intelligence or machine learning (AI/ML) prediction model, different causes require a different number and type of features to train the model to ensure the model accuracy. This requires an understanding of the underlying causes of an application issue. In addition, there may be a lag between the time of the causal event occurrence and the time of application performance degradation, and this time lag helps determine the prediction horizon, i.e., how far ahead the model predicts the future.

(2) Applications are executed on the edge of a cloud system (also referred to as edge clouds), and the heterogenous edge environment brings more challenges such as the customized feature selection for different types of edge clouds. Due to dynamic changes in edge environments, features may drift over time, meaning that relevant features for predicting a fault at one time may become obsolete at another time, which may significantly affect the prediction accuracy.

To tackle the challenges, time series prediction has been performed based on application's quality-of-service (QoS) metrics, yet such prediction may result in decreasing accuracy when a sudden infrastructure fault occurs. Another approach uses infrastructure data to predict application's QoS, where it assumes that a human expert would select relevant features for such prediction. For large scale, dynamic, and heterogenous edge cloud environments, this approach is not scalable. Thus, there is a need for automating the feature selection that not only considers the cause of the performance degradation but also takes into account the dynamicity of the edge environment.

### SUMMARY OF THE INVENTION

Embodiments include methods, network nodes, storage medium, and computer programs to select features for performance prediction of an application in a network. In one embodiment, a method comprises: receiving a request to select one or more features to predict a performance issue of an application, the request indicating a set of key performance indicators (KPIs) for the application to indicate the performance issue of the application and data of performance metrics collected from the network; selecting a first set of features from a plurality of features in response to the request, a feature from the plurality of features being selected to be included in the first set of features based on correlation between the feature and the set of KPIs; selecting a second set of features from the first set of features to predict the performance issue of the application, a feature from the first set of features being selected to be included in the second set of features based on a causal relationship between the feature and the set of KPIs; and causing prediction of the performance issue of the application based on the second set of features and corresponding time lags between the second set of features and the set of KPIs, wherein a time lag of a feature in the second set of features indicates a delay period between a change of the feature and impact of the change of the feature on a KPI within the set of KPIs.

In one embodiment, an electronic device comprises a processor and machine-readable storage medium that provides instructions that, when executed by the processor, are capable of causing the processor to perform: receiving a request to select one or more features to predict a performance issue of an application, the request indicating a set of key performance indicators (KPIs) for the application to indicate the performance issue of the application and data of performance metrics collected from the network; selecting a first set of features from a plurality of features in response to the request, a feature from the plurality of features being selected to be included in the first set of features based on correlation between the feature and the set of KPIs; selecting a second set of features from the first set of features to predict the performance issue of the application, a feature from the first set of features being selected to be included in the second set of features based on a causal relationship between the feature and the set of KPIs; and causing prediction of the performance issue of the application based on the second set of features and corresponding time lags between the second set of features and the set of KPIs, wherein a time lag of a feature in the second set of features indicates a delay period between a change of the feature and impact of the change of the feature on a KPI within the set of KPIs.

In one embodiment, a machine-readable storage medium that provides instructions that, when executed, are capable of causing a processor to perform: receiving a request to select one or more features to predict a performance issue of an application, the request indicating a set of key performance indicators (KPIs) for the application to indicate the performance issue of the application and data of performance metrics collected from the network; selecting a first set of features from a plurality of features in response to the request, a feature from the plurality of features being selected to be included in the first set of features based on correlation between the feature and the set of KPIs; selecting a second set of features from the first set of features to predict the performance issue of the application, a feature from the first set of features being selected to be included in the second set of features based on a causal relationship between the feature and the set of KPIs; and causing prediction of the performance issue of the application based on the second set of features and corresponding time lags between the second set of features and the set of KPIs, wherein a time lag of a feature in the second set of features indicates a delay period between a change of the feature and impact of the change of the feature on a KPI within the set of KPIs.

By implementing embodiments as described, the features are selected automatically without any human expert involvement. They not only output the causal correlated features for a given fault, but also provide the time lags between the features and the KPIs. This helps a prediction model determine its prediction horizon to achieve a higher accuracy.

### BRIEF DESCRIPTION OF THE DRAWINGS

The invention may be best understood by referring to the following description and accompanying drawings that are used to illustrate embodiments of the invention. In the drawings:

FIG. 1 illustrates the input/output and the functional components in a feature selector per some embodiments.

FIG. 2 illustrates functional blocks for performance management and optimization in a network per some embodiments.

FIG. 3 is a flow diagram illustrating the operations to serve a feature selection request per some embodiments.

FIG. 4 is a flow diagram illustrating the operations to serve a parameter optimization request per some embodiments.

FIG. 5 illustrates interactions of feature reduction and causal/temporal feature selection modules and their internal components per some embodiments.

FIG. 6 is a flow diagram illustrating the operations to reduce feature based on a feature selection request per some embodiments.

FIG. 7 is a flow diagram illustrating the operations to identify causal and temporal relationship between selected features and KPIs based on a feature selection request per some embodiments.

FIG. 8 illustrates feature selection based on a feature drift per some embodiments.

FIG. 9 illustrates feature selection parameter adjustment for feature selection per some embodiments.

FIG. 10 is a flow diagram illustrating the operations to select features to predict application performance per some embodiments.

FIG. 11 illustrates an electronic device implementing feature selection for performance prediction of an application in a network per some embodiments.

FIG. 12 illustrates an example of a communication system in accordance with some embodiments.

FIG. 13 illustrates a user equipment per some embodiments.

FIG. 14 illustrates a network node per some embodiments.

FIG. 15 is a block diagram of a host, which may be an embodiment of the host 1216 of FIG. 12, per various aspects described herein.

FIG. 16 is a block diagram illustrating a virtualization environment in which functions implemented by some embodiments may be virtualized.

FIG. 17 illustrates a communication diagram of a host communicating via a network node with a UE over a partially wireless connection per some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other. A “set,” as used herein, refers to any positive whole number of items including one item.

### Performance Prediction at Application Level

Embodiments of the invention aim at selecting features to predict performance at application level in a network, including cloud system(s) and/or wireless/wireline networks. The applications at the application level may include user applications or services, which require a certain quality-of-service (QoS) corresponding to user experience, and they are realized through deploying network functions or microservices in a network infrastructure. Such infrastructure includes the distributed, heterogenous edge cloud infrastructure and core networks that aggregate traffic from various applications and provide value-added services.

Identifying network performance issues may be accomplished through monitoring infrastructure metrics of the network. For example, artificial intelligence/machine learning (AI/ML) are used for predicting infrastructure (e.g., central/graphics processing units (CPU/GPU), memory, network) faults before they occur, thus providing a lead time for the system to take preventive steps. Yet it remains challenging to predict performance at application level based on the network performance issues.

One approach to understand the relationship between an application issue (e.g., performance degradation and/or service disruption) and its potential underlying cause (e.g., infrastructure fault) is to use causality discovery algorithms to infer causal relationships, if any, from observational time series data. Granger Causality is one of the first and more popular approaches proposed to discover causality. According to Granger Causality, a time series X Granger-causes Y, if past values of X provide unique, statistically significant information about future values of Y. One of the shortcomings of standard Granger Causality is that it is not applicable to real-world causal relationships that are mainly non-linear. Also, Granger's performance suffers in dynamic systems with weak to moderate coupling, and it cannot handle non-stationary data.

To overcome these shortcomings, advanced approaches based on Granger were proposed, e.g., Temporal Causal Discovery Framework (TCDF). Given multiple time series as input, TCDF discovers causal relationships between these time series and returns a causal graph. TCDF uses attention-based Convolutional Neural Network (CNN) combined with a causal validation step. It also discovers the time delay between cause and its effect.

Another approach for causality discovery is the constraint-based approach, which exploits conditional independencies to build a skeleton between variables. The skeleton is further oriented according to a set of rules that define constraints on admissible orientations. The Peter-Clark Momentary Conditional Independency (PCMCI) algorithm is a known constraint-based approach that is suitable for large-scale datasets and can find both linear and non-linear time-delayed dependencies.

In addition to causal discovery approaches, time series distance or similarity measurement techniques such as Dynamic Time Warping (DTW) or Pearson Correlation Coefficient can be utilized to infer the similarity of behavior in two time series. However, these techniques do not provide any causality relationship nor a time lag between two time series. Moreover, Time Lagged Cross Correlation (TLCC) is a time lag discovery approach, which shifts two time series against each other to find the interval at which peak similarity is observed. As such, the time lag between two series can be determined.

Note that a causal discovery approach should update the causal relationships once there is a feature drift, i.e., when the importance of features change. This can occur due to changes in the environment, e.g., traffic change, or software/hardware re-configurations that can cause new causal relationships or deprecate the old ones. Dynamic feature selection mechanisms may be used to address this issue.

Some systems have been proposed to predict application-level metrics using infrastructure-level metrics. For example, it is proposed to implement a cloud monitoring system along with a data analytics pipeline that processes and gathers data, and that may discover correlation between infrastructure- and application-level metrics. The system performs hierarchical clustering using DTW to cluster the infrastructure and application time series metrics separately to find metrics that have similar behaviors. Next, it identifies similar infrastructure and application clusters using DTW and further analyzes the top 1% similar cluster by domain experts to decide which metrics are correlated. Moreover, it uses Time Lagged Cross Correlation (TLCC) to find the time lag between the chosen metrics.

Yet these systems define a fixed ratio of feature selection, which is not flexible for heterogenous edge clouds because different types of clouds may have different resource requirements. Furthermore, the proposed metric selection based on human expert is not feasible for large-scale, dynamic edge environments.

Another set of systems uses historical values of QoS metrics to predict the future values of the QoS metrics, e.g., using genetic programming for time aware dynamic QoS forecasting in web services deployed in clouds. A system taking this approach considers statistical learning, machine learning, and a cross-approach selection mechanism for modeling and forecasting QoS. Additionally, the influence of the dynamic properties of QoS attributes (i.e., the size of the train and test datasets and sampling rate, on prediction accuracy) is examined in the system.

With applying QoS features (e.g., using historical QoS data) to predict future QoS, the historical data is required to contains certain QoS degradations following certain patterns of distributions. Yet in real network implementation, QoS degradation might be affected by various infrastructure problems not following a pattern. In such cases, these methods may suffer from non-ideal prediction accuracy.

Additionally, a QoS prediction model is built by extracting and combining features from diverse domains and sources in some prior approaches. Yet it could be cumbersome by merging features from multiple domains and training one model for predicting all. Such methods may also be less efficient for predicting a fault for a specific edge site and less flexible to handle frequent environment changes.

To overcome these limitations of prior approaches, embodiments of the invention automatically (without human intervention) select features, using a feature selector, for application issue prediction in a network, including one or more cloud systems and/or wireless/wireline networks. The feature selector may be implemented in an electronic device, which may be a host in a cloud system, or a network node or a user equipment (UE)/wireless device in a wireless/wireline network.

In some embodiments, the feature selector does the feature selection for an application by 1) reducing the feature searching space, 2) finding the causal and temporal relationship between the selected features and the application's Key Performance Indicators (KPIs), and 3) returning the features causally related to the KPIs, together with their time lags to the KPIs. The output can be used for fault prediction model training or retraining. The time lag of a feature indicates a delay period between a change of a feature and impact of the change of the feature on a KPI within the KPIs. The feature change is the change of the feature characteristics, e.g., the feature being a container's CPU usage, and the feature is deemed to be changed when the container's CPU usage as observed changed from 25% to 55%. Such change will affect the application's KPI, e.g., the response time of the application. The predicted time lag is 10 seconds, which means that the performance of the application will be degraded after 10 seconds of the container's CPU changed from 25% to 55%. Note that the time lag does not equal to prediction horizon in some embodiments, where it only refers to the time difference between the change of a feature and its impact observed on a KPI.

In some embodiments, the knowledge of the selected features is stored in a KPI Correlation Knowledge Base (KB), which facilitates the future feature selections for the same underlying fault type for an application issue. The correlation knowledge is updated each time after a feature selection. Additionally, the feature selector may implement a function to adjust its parameters to optimize the feature selection, which enables fulfilling some prediction model optimization goals such as increasing the model performance and reducing the model resource utilization.

### Feature Selection Deployment Environment

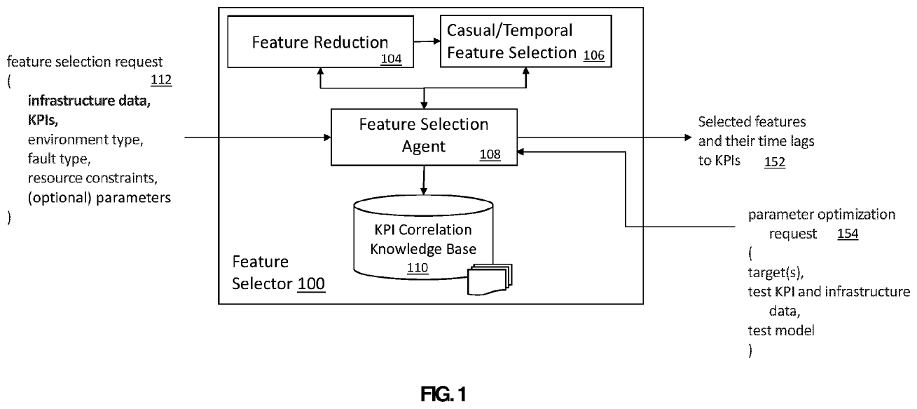

Embodiments of the invention automatically select one or more features for predicting application issues in a network, including cloud system(s) and/or wireless/wireline networks. FIG. 1 illustrates the input/output and the functional components in a feature selector per some embodiments. A feature selector 100 may be implemented as a software module or hardware logic in an electronic device of a network. The feature selector 100 receives the feature selection requests and returns the selected features and their time lags to the application's KPI(s). It includes functional components such as a feature selection agent 108, a feature reduction module 104, a causal/temporal feature selection module 106, and a KPI correlation knowledge base 110.

The feature selection agent 108 is responsible for handling the feature selection requests in some embodiments. The parameters of a request 112 include one or more of the following:

1) The infrastructure data: The raw data collected from the network. It might include the hardware level resource monitoring data, cloud management system data, virtual machine (VM), or/and container level monitoring data, together with the feature names. The request may indicate one or more storage locations from which the infrastructure data is to be obtained. In some embodiments, the storage locations are known, and the parameter of infrastructure data only needs to indicate the type of corresponding infrastructure data, and the feature selection agent may select and collect the data based on the parameter.

2) KPI(s): The monitoring data and feature names for the KPI(s) that indicate the performance degradation of the application. Note that the terms of KPI and application KPI are used interchangeably herein.

3) Environment type: The category of the network type such as the involved edge cloud for the application, where the categorization may be based on the capacity of edge clouds, hardware type, type of service provisioning, and resource type, among others. The environment type indicates the type of network (e.g., an edge cloud).

4) Fault type: The category of a fault. The faults triggered by the same/similar event may fall into the same category.

5) Resource constraints: The constraints of resource utilization for the feature selection request. The system may only dedicate a certain amount of resources for the feature selection request and this parameter indicates the specific resource constraints that limit the extent of resource usage for the feature selection request.

6) One or multiple feature selection parameters: These feature selection parameters may be provided explicated by a request. If not specified, system default values are used.

These parameters are explained in further detail herein below. In some embodiments, the infrastructure data and KPI(s) are mandatory while others are optional parameters to facilitate the feature selection and the interaction with the KPI correlation KB 110.

Upon receiving the feature selection request, the feature selection agent 108 will query the KPI correlation KB 110 and if more features need to be selected, it will call the feature reduction module 104 to start the feature selection process. After that, the feature selection agent 108 will update the KPI correlation KB 110 and output the selection results 152, e.g., the selected features and their time lags to the KPI(s).

The feature selection agent 108 may also receive the parameter optimization request 154. The parameters are the internal feature selection parameters that control the relevance level and the number of the features to be selected. Examples are the high correlation threshold and the maximum number of features selected. Adjusting these parameters can help fulfill the operator's feature selection target, e.g., to reduce resource usage and to enhance the prediction accuracy. The details of the parameter optimization can be found in the Feature Selection Agent Section herein below.

The feature reduction module 104 and causal/temporal feature selection module 106 are responsible for executing the feature selection and outputting the selected features and their time lags to the KPI(s). The feature reduction module 104 is responsible for reducing the number of features. The step is required for saving the cost of causal/temporal analysis. This is because the existing techniques used for causal/temporal analysis usually do one-by-one feature comparison and the cost of them increases significantly to the number of features included in the comparison. When the number of features in the infrastructure data is large (e.g., >1000), it is very computationally expensive to run causal analysis for all the features. Thus, reducing the feature space for causal analysis is necessary. After feature reduction, the causal/temporal feature analysis is done on a much smaller feature space in the causal/temporal feature selection module 106.

The selected features for predicting application issues can be stored in the KPI Correlation KB 110 for reusability. The KPI Correlation KB 110 can be shared among different sites (e.g., different edge clouds), and it can significantly reduce the cost of feature selection. Due to the high dynamicity of the distributed sites, the knowledge of KPI correlation may become less relevant over time. To overcome this, some embodiments require a knowledge update after each feature selection, while some embodiments additionally/alternatively design a weighted feature correlation knowledge that leverages both the historical feature correlation score and the current correlation score.

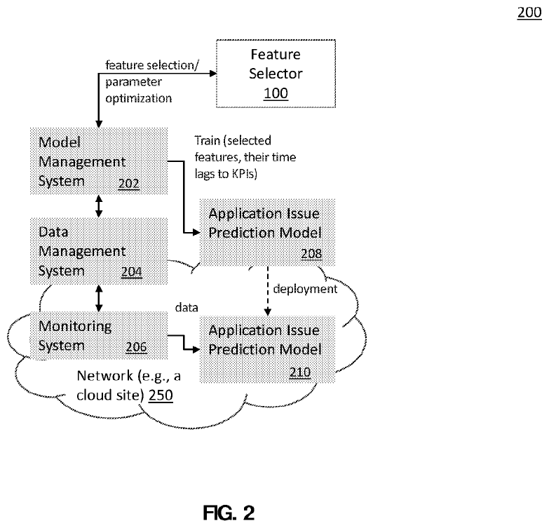

The selected features from the feature selector 100 may be used in a larger system for performance management and optimization. FIG. 2 illustrates functional blocks for performance management and optimization in a network per some embodiments. Each functional block in the system 200 may be implemented in an electronic device, but one or more of the functional blocks may be integrated with the feature selector 100 in a single electronic device.

The feature selector 100 takes feature selection requests and parameter optimization requests and provides feature section results to a model management system 202. The model management system 202 manages machine learning models for performance management. The model management system 202 trains an application issue prediction model module 208, which stores the application issue prediction models trained through the selected features and their time lags to KPIs, which are received from the feature selector 100.

The data management system 204 provides the infrastructure data used by the feature selector 100, and it may process the infrastructure data prior to passing on the data to the feature selector 100. The data management system 204 receives the infrastructure data from a monitoring system 206, which may be implemented in the network 250 with multiple monitoring agents distributed throughout the network. The infrastructure data may be fed to the deployed application issue prediction model 210 from the application issue prediction model module 208, so that the deployed application issue prediction model 210 may predict a performance degradation of an application based on the infrastructure data.

The performance management and optimization system 200 automatically selects the features for a prediction model, without any human expert involvement. The selected features (e.g., stored in a KPI correlation knowledge base) and trained prediction models, which may be stored in a database or another storage location, may be shared among multiple locations in the network 250 thus provide better application-level performance enhancement throughput the network 250.

### Parameters for Feature Selection

For feature selection and parameter optimization, various parameters (also referred to as variables) are defined in some embodiments. Correlation score S′ is the correlation value between a time series and another time series. For example, S may measure the correlation between two network features or between a network feature and a KPI metric. Note that a KPI metric may be a time series metric. Correlation score is also referred to as score herein, and the two terms are used interchangeably.

Weight W_{f} is a weighted correlation. It can be calculated using the following equation:

$${W}_{f} = α * {W}_{f \_ history} + ( 1 - α ) * {S}_{f} \qquad ( 1 )$$

In Formula (1), W_{f} represents the current correlation weight between feature f and the given KPI, and W_{f_history} represents the historical correlation weight between feature f and the KPI metric. S_{f} is the current correlation score between feature f and the KPI metric. The values α (0<α<1) is the weight update coefficient, which can be adjusted to reflect the importance of the historical weight over the current score. For example, in a highly dynamic system where the current value is more important, we can set a to a value larger than, say, 0.5.

W_{tc} represents a threshold correlation between a feature and a KPI metric, over the threshold correlation indicating that the feature is sufficiently correlated to the KPI metric (also referred to as highly correlated).

I_{tc} represents a threshold correlation between two features, over the threshold correlation indicating that the two features are sufficiently correlated.

Fₘₐₓ represents the maximum number of features that a feature selector may select at a time (e.g., through a feature selection request).

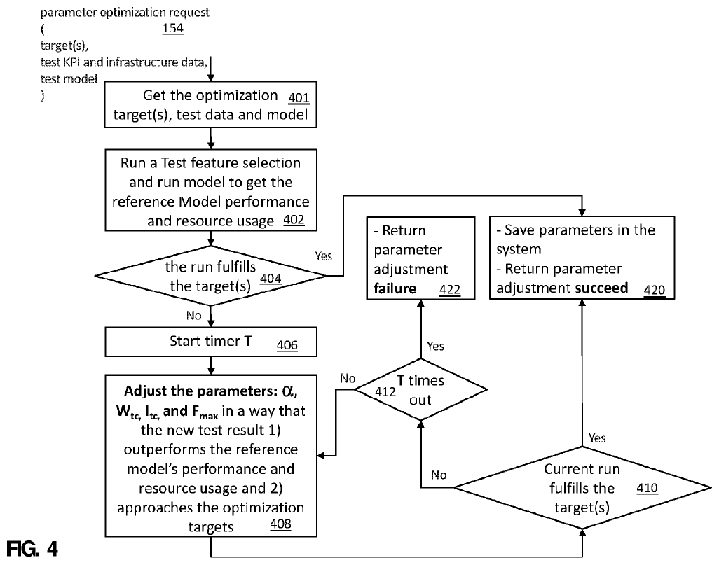

These variables α, W_{tc}, I_{tc}, and Fₘₐₓ are configurable parameters. The values of the variables can be initialized/optimized by the parameter optimization process (see FIG. 4). They can also be configured for one time use by a feature selection request when there is a need.

### Weight Update

Each feature applicable in a network may be assigned to a weight in some embodiments. The pseudo code below shows the operations to update the weight once there is a request for weight update, and to re-select the features that have a weight greater than a given threshold.

Algorithm: Weight Update Algorithm

| | Input: Application KPI (K), Feature Set (F), Feature Weight Vector |
|---|---|
| | (W), weight update |
| | Output: Currently Selected Features (CSF) |
| 1: | Initialize W at time 0 (W₀ ← 0) |
| 2: | if there is a weight update request at time t then |
| 3: | RF ← Reduce Features (K, F) |
| 4: | S_{RF} ← Get correlation scores between (K, RF) |
| 5: | for each feature (f) in RF do |
| 6: | W_{f,t} = α.W_{f,t-1} + (1− α).S_{f} |
| 7: | if W_{f,t ≥} W_{tc} then |
| 8: | Add feature f to CSF |
| 9: | End |
| 10: | End |
| 11: | return CSF as dynamic selected features |
| 12: | end |

### Feature Selection Agent

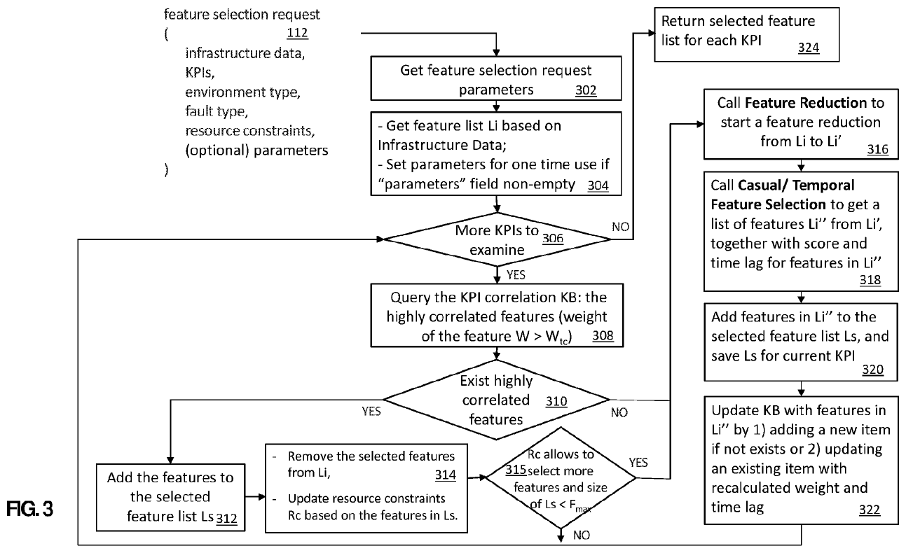

A feature selection agent (e.g., the feature selection agent 108) is responsible for handling a feature selection request. FIG. 3 is a flow diagram illustrating the operations to serve a feature selection request per some embodiments.

At reference 302, the feature selection request parameters are received from the feature selection request 112 at reference 302. At reference 304, the feature selection agent gets a feature list Li based on the indicated infrastructure data in the feature selection request 112. The feature list Li may include all the features that are related to the infrastructure data. For example, when the infrastructure data includes monitoring data of a VM/container in an edge cloud, the feature list includes all the types of measurements performed on the VM/container over time, such as GPU/CPU execution resources, memory resources, storage space, and/or the bandwidth used by the VM/container. When the “parameters” field of the feature selection request is not empty, they are taken as parameters of the feature selection process.

At reference 306, the feature selection agent determines whether there are more KPIs from the feature selection request to be examined. If so, the feature selection agent queries the KPI correlation KB for a current KPI and identifies highly correlated features in the KPI correlation KB (W>Wtc) at reference 308.

At reference 310, the feature selection agent determines whether there are any identified highly correlated features in the KPI correlation KB from reference 308. If so, the flow goes to reference 312, and the selected features are added to the selected feature list Ls at reference 312. Then at reference 314, the selected features are removed from Li, and update resource constraints Re based on the features in Ls. If resource constraints allow more features to be selected (e.g., the indicated resource constraint in the feature selection request is CPU usage less than 10% and only 3% are used by serving the feature selection request) and the number of selected features are insufficient for the feature selection request (e.g., selected features<Fₘₐₓ) at reference 315, more features may be selected, and the flow continues to reference 316. Otherwise, the feature list Ls is complete for the current KPI and the flow continues to reference 306.

Back to reference 310, if the feature selection agent determines that there is no identified highly correlated features in the KPI correlation KB, the flow goes to reference 316, where a feature reduction function is called to start a feature reduction from Li to Li′.

Once the feature list is reduced to Li′, the flow continues to reference 318, where a causal/temporal feature selection function is called to get a list of feature Li″ from Li′, together with correlation scores and time lag for features in Li″.

Then at reference 320, the features in Li″ are added to the selected feature list Ls and save the feature list Is for the current Ls at reference 320.

Then the feature selection agent updates the KPI correlation KB with features in Li″ by (1) adding a new item if none exists, (2) updating an existing item with recalculated weights (e.g., using Formula (1)) and time lag (see discussion below) at reference 322. The updating of the KB based on the feature selection makes the KB adaptive to the current network situation—a weighted sum of the correlation and historical correlation between the feature and the set of KPIs as saved in a knowledge base enables a fresh and dynamic KPI correlation KB.

Back to reference 306, if the feature selection agent determines that all the KPIs from the feature selection request have been examined, the flow completes and the selected feature lists of corresponding Ls, each for a KPI indicated in the feature selection request 112, are returned.

Note that the system allows for achieving a balance between reusing features from the KPI correlation KB to reduce the feature selection cost and selecting new features to adapt to the environment changes. This can be done via adjusting the parameters Wtc and a in some embodiments.

The feature selection agent is also responsible for handling parameter optimization request in some embodiments. FIG. 4 is a flow diagram illustrating the operations to serve a parameter optimization request per some embodiments. The parameter optimization may be triggered by a parameter optimization request such as the parameter optimization request 154. In some embodiments, the parameter optimization request is sent by the model management system 202, which either initializes the feature selector 100 in a new environment or targets to optimize a prediction model via adjusting the features for training.

At reference 401, the one or more optimization targets, test KPI and corresponding infrastructure data, and test model are obtained from the parameter optimization request. At reference 402, based on the test data and prediction model, the feature selection agent uses the current parameters to execute a feature selection, and runs the test model to get a reference model performance and resource utilization.

At reference 404, it is determined whether the reference performance and resource utilization fulfill the optimization targets. If the reference performance and resource utilization do not fulfill the optimization target, the flow goes to reference 406, where a timer is set for the parameter optimization process.

At reference 408, the optimization (including one or more times of parameter adjustment, feature selection, and application issue prediction model training and testing) is performed, where the parameters such as α, Wtc, Itc, and Fₘₐₓ are adjusted so that the new test result (1) outperforms the reference model's performance and resource usage without the adjustment, and (2) approaches the optimization target indicated in the parameter optimization request.

At reference 410, it is determined whether the adjustment at reference 408 fulfills the optimization targets. If not, the flow goes to reference 412 to determine whether the optimization has run out of time, if not, the flow returns to reference 408 for further optimization, if the optimization does run out of time, the flow goes to reference 422 with an indication of a parameter adjustment failure at reference 422.

If the adjustment at reference 408 fulfills the optimization targets, the flow goes to reference 420, where the trained parameters are saved in the system for the model, and the feature selection agent indicates a parameter adjustment success at reference 420.

The new feature selection process thus may use the adjusted parameters to bring about better results than the reference result toward the optimization target. The parameter adjustment can be done via applying a proper hyperparameter adjustment method such as random search, grid search, and Bayes optimization at reference 408.

The optimization to adjust the parameters at reference 408 may also be performed through reinforcement learning or evolutionary algorithms such as Particle Swarm Optimization (PSO), where parameters are obtained through iterative updating of parameters until target performance is reached.

### KPI Correlation Knowledge Base (KB)

The KPI Correlation KB stores the facts about an application issue and its relationship to the features that could be used for predicting the application issues (e.g., fault, performance degrade, service interrupt). The KPI Correlation KB may include the following terms for an application in some embodiments:
Application A: The application running in a cloud system;
App type Ta: Type of an application, e.g., web_app, XR_app, and 5G_core_app;
Condition type (′: Describes the fault condition, e.g., CPU high utilization;
Environment type: Describes the type of the network that the application is running on, e.g., a mobile edge, a video stream edge, an extended reality (XR) edge;
KPI K: The key performance indicator for the application;
Features M: The set of metrics that have a correlation with the KPI metric;
Time lag TL: Describes the time relationship between the distribution variations of a feature and KPI;
Weight W: The weighted correlation score between a feature and a KPI; and
Wtc: The high correlation threshold between a feature and a KPI.

Additionally, the KPI Correlation KB may include the following (semantic) relations among the terms relating to the application:
A is of type Ta;
A has KPIs K₁, . . . , Kₙ;
K is correlated with feature set M under condition C in environment E, where each item Mi is with weight Wi and with time lag TLi from KPI K; and
K is highly correlated to Mi if Wi is larger than Wtc.

An example knowledge can be found as follows:
(i) Sock_shop is of type a web_app;
(ii) A web_app has KPIs response_time, number_of_queries_per second;
(iii) Response_time is correlated to features [container_cpu_usage is with weight 0.8 and with time lag 10 seconds, vm_cpu_usage is with weight 0.6 and with time lag 20 seconds, container_network_packet_received is with weight 0.55 with time lag 10 seconds] under condition type “CPU/memory over utilization” in environment “mobile edge”; and
(iv) Response_time is correlated to features [container_network_packet_received with weight 0.9 and with time lag 10 seconds] under condition type “network congestion” in environment “mobile edge.”

In some embodiments, records are stored in the KPI Correlation KB, where a record maps to an application, a KPI, and a feature correlated with the KPI with a determined correlation weight Wi and corresponding time lag TLi. The record may be updated after a feature selection (see reference 322). In some embodiments, the records may be stored and sorted based on the types of networks and the types of application performance issues related to the features.

The following queries may be executed with the above-mentioned knowledge:
(1) _Query: Robot_shop is of type web_app running in a “mobile edge”, what are the correlated metrics for its KPI response_time under condition “CPU/memory over utilization”?
(1) _Answer: [container_cpu_usage is with weight 0.8 and with time lag 10 seconds, vm_cpu_usage is with weight 0.6 and with time lag 20 seconds, container_network_packet_received is with weight 0.55 with time lag 10 seconds].
(2) _Query: What are the highly correlated features for the response_time of Robot_shop (Wtc=0.7)?
(2) _Answer: [container_cpu_usage is with weight 0.8 and with time lag 10 seconds].

While the KPI correlation KB above is given as an example, other ways of organizing a KB may be implemented, along with a variety of ways to indicate knowledge and executing queries. Embodiments of the invention are not limited to particular ways to implement the KPI correlation KB.

### Feature Reduction and Causal/Temporal Feature Selection

Feature reduction and selection are shown in FIG. 1 as performed by feature reduction module 104 and causal/temporal feature selection module 106. The purpose of the feature reduction module 104 is to reduce the size of the features that are collected from a monitoring system. It is important to reduce the number of features prior to selecting features for further analysis because a monitored network (e.g., an edge cloud environment) can have thousands of features and it would be prohibitively expensive to perform the causal/temporal analysis on all these features in the causal/temporal feature selection 106 directly.

The causal/temporal feature selection 106 is responsible for finding a causal relationship and a time lag between the application KPI(s) and the features that have causal relation with application KPI(s). This information is useful to understand the causality between different features, i.e., what features have causal relationship with the KPI metric, and what is the time lag between the alterations of a feature and the KPI metric.

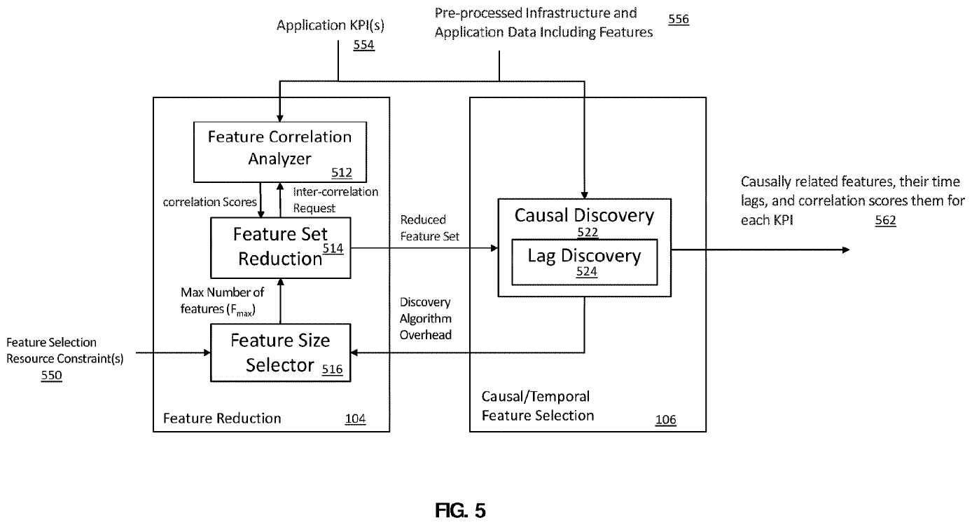

FIG. 5 illustrates interactions of feature reduction and causal/temporal feature selection modules and their internal components per some embodiments. The feature reduction module 104 includes the following internal components in some embodiments:

Feature Correlation Analyzer: The feature correlation analyzer 512 receives the application KPI(s) from a feature selection request as well as pre-processed data and features as the inputs. The data can include infrastructure and application data. The feature correlation analyzer 512 can find the correlation between the KPI metric(s) and other features or the correlation between the features by calculating a correlation score, S. DTW, Pearson Correlation Coefficient, or other similar correlation analysis tools can be used to implement the feature correlation analyzer 512.

Feature Set Reduction: The feature set reduction component 514 reduces the number of features in two steps. First, upon receiving correlation scores between the features and the KPI from the feature correlation analyzer 512, it sorts the features based on their correlation scores, and selects the top Fₘₐₓ features (which may be specified by the feature selection request 112 or a default in a Feature Selector 100 or specified by the feature correlation analyzer 512 described in the following). Next, it sends a request to the feature size selector 516 to find the correlation between the reduced features (inter-correlation between features). Then, it eliminates the redundant features that have a high correlation, i.e., the features with inter-correlation score above a given threshold (I>Itc). In some embodiments, only one of two features that are highly similar is selected. The elimination of the other feature in the two features may be based on which has a higher correlation score with the KPI in the feature selection request; and alternatively, the elimination may be performed randomly between the two highly similar features.

Feature Size Selector: The feature size selector 516 finds the maximum number of features (Fₘₐₓ) for reduction in some embodiments. This component considers some constraints such as resource utilization constraint for feature selection and the causal/temporal discovery overhead (in a function of “number of features”), to find the maximum number of features. The knowledge for feature size selector can be learned by a reinforcement learning agent (or another agent used in a different machine learning method), or it can be calculated if a feature size function (a function of resource constraint and the causal/temporal discovery overhead) is available.

The causal/temporal feature selection module 106 includes the following internal components in some embodiments:

Causal Discovery: The causal discovery component 522 receives the application KPI(s) under study, pre-processed data and features, and the reduced feature set from the feature reduction module 104 as inputs. It uses a causal discovery algorithm to infer causal relationships between the reduced features and the KPI(s). Causal discovery algorithms such as Granger Causality, Temporal Causal Discovery Framework (TCDF), and Peter-Clark Momentary Conditional Independency (PCMCI) can be used. Among them, some algorithms (e.g., TCDF) provide both causal relationships and time lag between features, while others only infer causal relationships; in the latter case, a separate time lag discovery algorithm can be used to find the time lag between features.

Lag Discovery: In case the algorithm executed in causal discovery component 522 does not provide time lags between features, a lag Discovery component 524 may find the time lag between features, which shows the time elapsed for a change in one feature to be seen in another feature. TLCC is one example of a lag discovery algorithm.

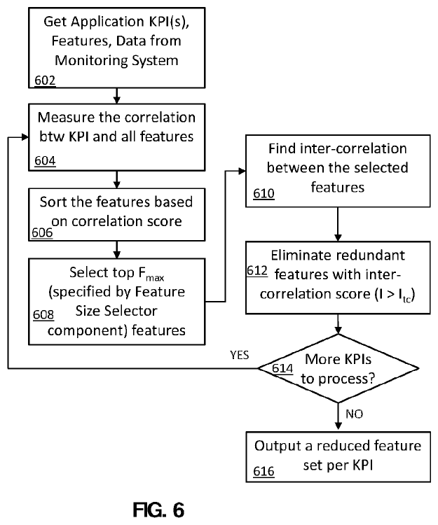

FIG. 6 is a flow diagram illustrating the operations to reduce feature based on a feature selection request per some embodiments. The operations are performed through a feature reduction function and by feature reduction module 104 in some embodiments.

At reference 602, a set of application KPIs and features are obtained (e.g., based on the feature selection request 112), and infrastructure data are received from a monitoring system (e.g., the monitoring system 206). Then the correlation between a KPI and all the features are measured at reference 604. The measurement may be through computing a correlation score S′ as discussed herein above.

Then the features are sorted based on the correlation score at reference 606. At reference 608, the features with the highest correlation scores up to Imax features (which may be specified by the feature selection request 112 or a default in the feature selector 100 or specified by the feature size selector 516 described herein) are selected.

At reference 610, the inter-correlation between the selected features from reference 608 are measured, and the redundant features are eliminated when the inter-correlation is over a specific threshold (I>Itc).

At reference 614, it is determined whether more KPIs are available for feature selection, if so, the flow goes back to reference 604. Otherwise, the flow goes to reference 616, and the reduced feature set for the current KPI is provided as output.

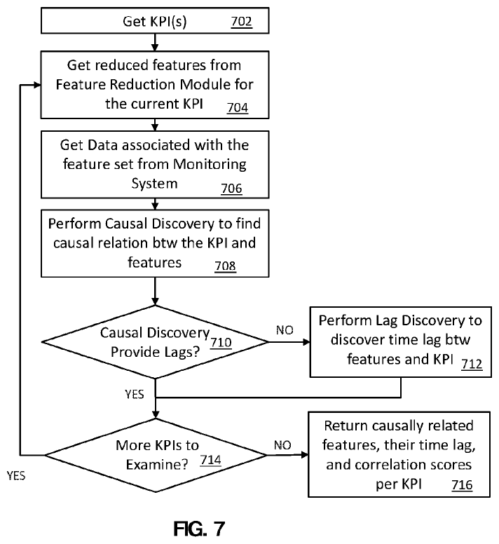

FIG. 7 is a flow diagram illustrating the operations to identify causal and temporal relationship between selected features and KPI(s) based on a feature selection request per some embodiments. The operation is performed through a causal/temporal feature selection function and by the causal/temporal feature selection module 106 in some embodiments.

At reference 702, a set of application KPI(s) are obtained (e.g., from the feature selection request 112). At reference 704, the reduced features are obtained from the feature reduction module 104 for the current KPI.

At reference 706, infrastructure data associated with the reduced features are obtained from a monitoring system (e.g., the monitoring system 206). Then causal discovery is performed to find the causal relationship between the KPI and the features at reference 708.

At reference 710, it is determined whether the causal discovery provides time lag information for the features, if not, the flow goes to reference 712, where lag discovery is performed to discover the time lag between the feature and the KPI. The flow then goes to reference 714, which the flow also goes to when the causal discovery is determined to provide lag information for the features at reference 710.

At reference 714, it is determined whether more KPIs are to be examined, if so, the flow returns to reference 704. If not, then the causally related features and their time lags, and their corresponding scores per KPI are returned at reference 716. The incoming feature selection request is successfully served.

As discussed, a feature selector receives a feature selection request for a given fault and obtains the infrastructure data and the KPI(s) that the fault impacts. In some embodiments, the feature selector queries a KPI Correlation Knowledge Base for the highly correlated features, and if needed, (1) calls a feature reduction function to reduce the feature searching space, (2) calls a causal/temporal feature selection function to select the features with causal and temporal relationship with the KPIs, and (3) updates the knowledge base with the newly calculated correlation scores. The causal related features and their time lags to the KPI are then returned for the feature selection request. In some embodiments, the feature selector may also receive a parameter optimization request and adjust the parameters so that the selected features can help fulfill the optimization targets of the prediction model.

These embodiments provide solutions that automatically select the features for a prediction model, without any human expert involvement. They not only output the causal correlated features for a given fault, but also provide the time lags between the features and the KPIs. This helps a prediction model determine its prediction horizon to achieve a higher accuracy. Additionally, the causally/temporally correlated features selected for a given fault are stored in a knowledge base for reusability and cost-saving purposes. Such solutions are well suited for networks including the dynamic edge cloud environments. First, as the feature selection is automated, it can be called periodically to allow a prediction model to be retrained to adapt to a feature drift. Second, the feature selection parameters can be adjusted so that the system can provide an optimal feature selection for a given environment.

### Use Cases

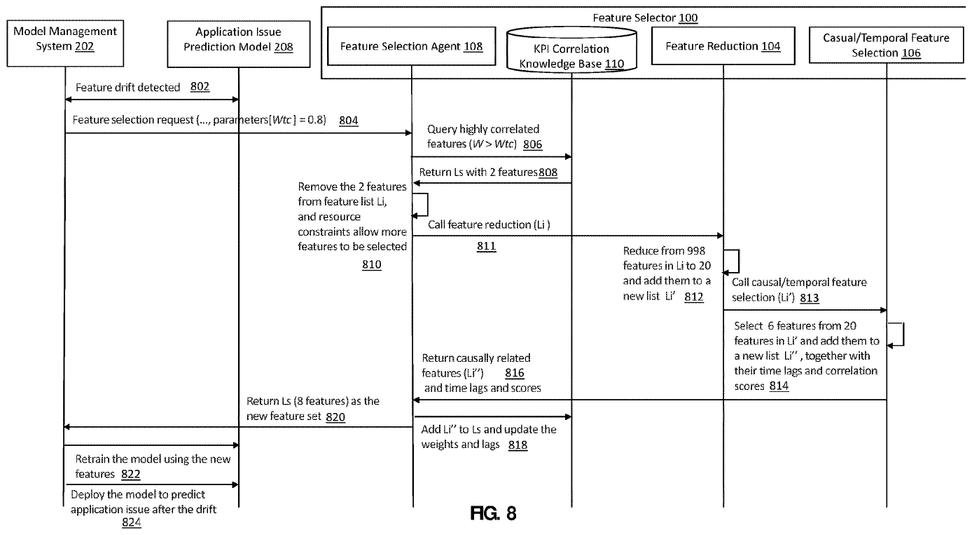

Embodiments of the invention may be applied to various networks, and this section describe two use cases for illustration. FIG. 8 illustrates feature selection based on a feature drift per some embodiments. The entities involved in the use case are explained herein above. A feature drift occurs when the importance of a feature changes due to dynamicity of the environment, which can include changes in the software or hardware configurations, or traffic changes. Once the importance of features changes, the causality relationship between the features can also be changed. The use case shows the update of the features, their causality relationship, and time lags.

The feature selection request may be initiated either once at the time when an incident occurs (e.g., changes in software/hardware configuration, or traffic changes), or periodically (e.g., bi-weekly or monthly). In case of incidental feature update, the model management system 202 monitors the accuracy drop for the application issue prediction model 208, and if the drop is triggered by some environment incidents, it will trigger a feature selection at reference 802. The periodical update can be configured if the environment is “known” to be very dynamic where the traffic changes frequently, leading to periodical feature drifts.

Once the feature drift is detected, a feature selection request is triggered and transmits to the feature selection agent 108 at reference 804. In this example, the optional parameter threshold correlation Wtc is given. The threshold correlation can be set according to the severity of the drift, e.g., a more severe drift requires a higher Wtc. In this example, a high correlation score of 0.8 with the KPI is set, which means that the selected features are required to have at least the correlation score with the KPI in the feature selection request.

At reference 806, the feature selection agent 108 queries the highly corrected features (W>Wtc). The KPI correlation KB 110 checks and identifies two features that have at least the correlation score of 0.8 at reference 808.

At reference 810, the feature selection agent 108 removes the identified two features from the feature list Li (that contains 1000 features) and adds them to the selected feature list L.s. It determines that the resource constraints allow more features to be selected and then calls the feature reduction function to further select features from the feature list Li at reference 811. See description of the similar operations at reference 312 to 316 above.

At reference 812, the feature reduction module 104 reduces the remaining 998 features in feature list Li to 20 features and adds the 20 features to a new feature list Li′. The feature reduction module 104 then calls the causal/temporal feature selection function for the new feature list Li′ at reference 813. The causal/temporal feature selection function then selects 6 features from the 20 features in the new feature Li′ and adds them to a causally related feature list Li″, together with their time lags and correlation scores at reference 814. The causally related features in Li″ and their time lags and correlation scores are returned at reference 816 to the feature selection agent 108. These operations are described at reference 316 to 320 as well.

The feature selection agent 108 then adds features in Li″ to Ls and updates the corresponding weights and lags at reference 818. The total of 8 features (2 from the KPI correlation KB 110+6 from the feature reduction and causal/temporal feature selection) are then returned as a response to the feature selection request at reference 820.

Additionally, the model management system 202 may use the new features in Ls to retrain the prediction model at reference 822, and the retrained model will be deployed to predict application issue after the feature drift (or periodically) at reference 824.

To put the parameter optimization (shown in FIG. 4) in the context of use case, FIG. 9 illustrates feature selection parameter adjustment for feature selection per some embodiments.

The parameter optimization is triggered when it is determined that a model is less than ideal. At reference 902, execution of a model within the application issue prediction model 208 causes a determination that the Mean Absolute Error (MAE) has been too high for a period of time. The threshold to make such a determination is set to 0.2.

At reference 904, the model management system 202 then transmits a parameter optimization request to the feature selection agent 108. The parameter optimization request indicates (1) the target of getting a model with MAE less than 0.2 and F1 of 0.85, (2) the model being LSTM_CNN1, which stands for a hybrid Long Short-Term Memory and a Convolutional Neural Network, and (3) the data to retrain the LSTM_CNN1 model being testing_data. Note that F1 refers to F1-score (or F-score), and it is a measure of a model's precision and recall on a dataset. It is used to evaluate binary classification systems, which classify examples into ‘positive’ or ‘negative.’

At reference 906, the feature selection agent 108 queries the KPI correlation KB 110 and tentatively set to select highly correlated features (Wtc>0.8) within. At reference 908, 10 features are returned from the KPI correlation KB 110 based on the query.

At reference 950, loop operations are performed to iterative adjust the parameters until the target is fulfilled. In one iteration, N features are selected for the testing_data at reference 910. The LSTM CNN1 model is trained and tested, which results in MAE of 0.25 and F1 of 0.87. Since the target is not fulfilled, the threshold correlation Wtc is adjusted to 0.85 with the step of change of 0.05.

Based on the updated threshold correlation, the feature selection agent 108 queries the KPI correlation KB 110 again to select 7 features at reference 912. Other parameters for the feature selection may be adjusted as well at reference 914 in this or another iteration, such as threshold correlation between two features Ite and the maximum number of features/max.

Through the iterations in the Loop within reference 950, it is identified at reference 952 that 5 features would achieve the target, resulting in MAE of 0.18 and F1 of 0.9, when the threshold correlation Wtc is adjusted to 0.9.

At reference 916, the selected 5 features are returned to respond to the parameter optimization request for the LSTM_CNN1 model with the optimized parameters. At reference 918, the selected features are used to retrain the model at the application issue prediction model 208. The retrained model may then be deployed to predict application issues at reference 920.

### Operations Per Some Embodiments

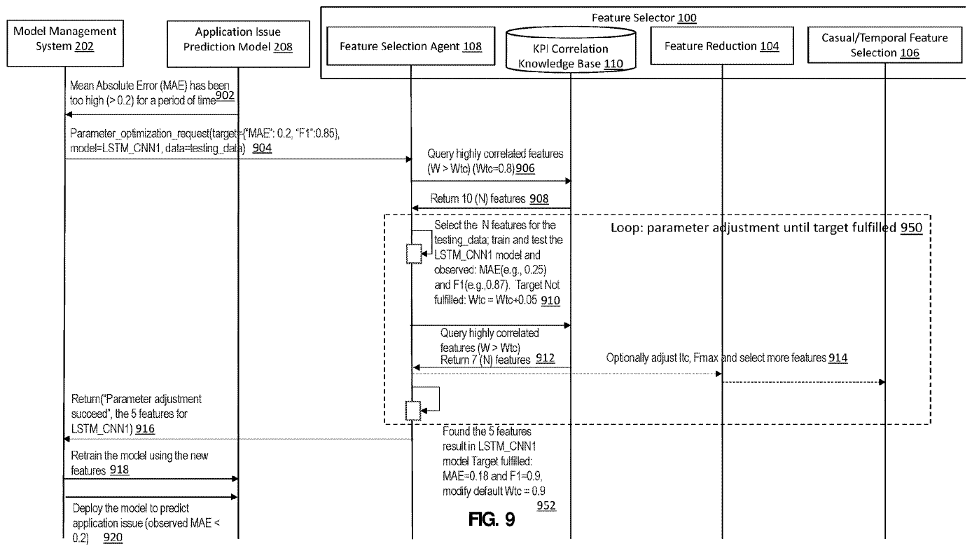

Embodiments of the invention describe operations to select features to predict application performance in a network, including cloud system and/or wireless/wireline networks. FIG. 10 is a flow diagram illustrating the operations to select features to predict application performance per some embodiments. The operations may be performed by an electronic device including a feature selector (e.g., the feature selector 100 discussed herein) to select features for performance prediction of an application in a network.

At reference 1002, a request is received to select one or more features to predict a performance issue of an application, the request indicating a set of key performance indicators (KPIs) for the application to indicate the performance issue of the application and data of performance metrics collected from the network. The request is the feature selection request 112 in some embodiments.

At reference 1004, a first set of features is selected from a plurality of features in response to the request, a feature from the plurality of features being selected to be included in the first set of features based on correlation between the feature and the set of KPIs. In some embodiments, the plurality of features and the first set of features are features in the feature list Li and Li′ discussed herein, respectively.

At reference 1006, a second set of features is selected from the first set of features to predict the performance issue of the application, a feature from the first set of features being selected to be included in the second set of features based on a causal relationship between the feature and the set of KPIs. In some embodiments, the second set of features are features in the feature list Li″ discussed herein.

At reference 1010, the feature selector causes prediction of the performance issue of the application is predicted based on the second set of features and corresponding time lags between the second set of features and the set of KPIs, where a time lag of a feature in the second set of features indicates a delay period between a change of the feature and impact of the change of the feature on a KPI within the set of KPIs. In some embodiments, the selected features from the feature selector (the second set of features) are provided to an application issue prediction model (e.g., the result of which may be deployed as the application issue prediction model 210), and that cause the application issue prediction model to perform the prediction based on the data of performance metrics collected from the network (e.g., the data being collected from the monitoring system 206). The corresponding time lag between the second set of features and the set of KPI(s) are used to set the prediction horizon.

In some embodiments, a weighted sum of the corresponding correlation and historical correlation between the feature included in the second set of features and the set of KPIs is saved in a knowledge base for the feature. The knowledge base has multiple records, a record mapping to one or more correlated features for a KPI.

In some embodiments, a first feature is selected from the first feature and a second feature within the plurality of features to be included in the first set of features while the second feature is eliminated based on correlation between the first and second features. The selection is to eliminate redundant features and the operations are discussed herein above (e.g., references 610 and 612).

In some embodiments, the feature is selected from the plurality of features to be included in the first set of features based on comparing a threshold and a correlation score that indicates the correlation between the feature and the set of KPIs. The threshold is the threshold correlation Wtc, and a feature is selected to be in the first set of features only when the correlation of the feature to a KPI in the set of KPIs is over the threshold.

In some embodiments, the request additionally indicates one or more input parameters on which the selection of the first and second sets of features is based, including a type of the network, a type of application performance issue to be predicted through the set of features, and a set of resource constraints to perform the feature selection, and a set of feature selection parameters to indicate a selection scope.

In some embodiments, the plurality of features are stored in a knowledge base based on one or more types of networks and types of application performance issues related to the features.

In some embodiments, the set of feature selection parameters includes one or more of a maximum number of features to be selected for the request, a correlation threshold to select the first set of features for the set of KPIs, a correlation threshold to eliminate redundant features from the first set of features.

In some embodiments, the operations also include querying, at reference 1008, a knowledge base to select one or more features from the knowledge base to be included in the second set of features when the one or more features correlate to the set of KPIs over the correlation threshold.

In some embodiments, values of the set of feature selection parameters are obtained through training using a known performance issue of the application, sets of key performance indicators (KPIs) for the application to indicate the known performance issue of the application, and data of performance metrics collected from the network.

In some embodiments, upon detecting that the second set of features no longer predict the performance issue of the application accurately, a reselection request to select one or more features is initiated at reference 1012 to predict the performance issue of the application, and the reselection request causes updating the second set of features. An example of feature reselection based on feature drift is given at FIG. 8.

### Devices Implementing Embodiments of the Invention

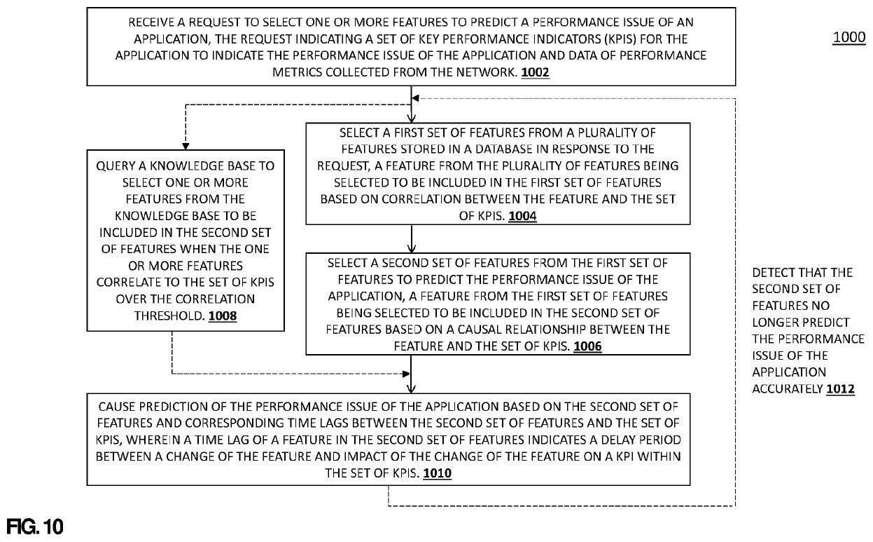

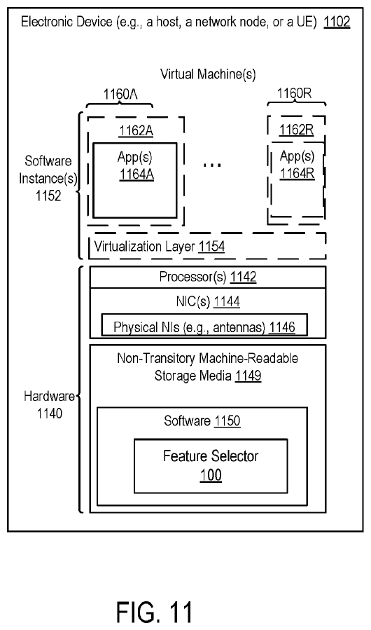

FIG. 11 illustrates an electronic device implementing feature selection for performance prediction of an application in a network per some embodiments. The electronic device may be a host in a cloud system, or a network node/UE in a wireless/wireline network, and the operating environment and further embodiments the host, the network node, the UE are discussed in more details herein below. The electronic device 1102 may be implemented using custom application-specific integrated-circuits (ASICs) as processors and a special-purpose operating system (OS), or common off-the-shelf (COTS) processors and a standard OS. In some embodiments, the electronic device 1102 implements the feature selector 100. Note a network node may also referred to as a network device in some embodiments.

The electronic device 1102 includes hardware 1140 comprising a set of one or more processors 1142 (which are typically COTS processors or processor cores or ASICs) and physical NIs 1146, as well as non-transitory machine-readable storage media 1149 having stored therein software 1150. During operation, the one or more processors 1142 may execute the software 1150 to instantiate one or more sets of one or more applications 1164A-R. While one embodiment does not implement virtualization, alternative embodiments may use different forms of virtualization. For example, in one such alternative embodiment, the virtualization layer 1154 represents the kernel of an operating system (or a shim executing on a base operating system) that allows for the creation of multiple instances 1162A-R called software containers that may each be used to execute one (or more) of the sets of applications 1164A-R. The multiple software containers (also called virtualization engines, virtual private servers, or jails) are user spaces (typically a virtual memory space) that are separate from each other and separate from the kernel space in which the operating system is run. The set of applications running in a given user space, unless explicitly allowed, cannot access the memory of the other processes. In another such alternative embodiment, the virtualization layer 1154 represents a hypervisor (sometimes referred to as a virtual machine monitor (VMM)) or a hypervisor executing on top of a host operating system, and each of the sets of applications 1164A-R run on top of a guest operating system within an instance 1162A-R called a virtual machine (which may in some cases be considered a tightly isolated form of software container) that run on top of the hypervisor—the guest operating system and application may not know that they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1140, directly on a hypervisor (in which case the unikernel is sometimes described as running within a LibOS virtual machine), or in a software container, embodiments can be implemented fully with unikernels running directly on a hypervisor represented by virtualization layer 1154, unikernels running within software containers represented by instances 1162A-R, or as a combination of unikernels and the above-described techniques (e.g., unikernels and virtual machines both run directly on a hypervisor, unikernels, and sets of applications that are run in different software containers).

The software 1150 contains the feature selector 100 that performs operations described with reference to operations as discussed relating to FIGS. 1 to 10. The feature selector 100 may be instantiated within the applications 1164A-R. The instantiation of the one or more sets of one or more applications 1164A-R, as well as virtualization if implemented, are collectively referred to as software instance(s) 1152. Each set of applications 1164A-R, corresponding virtualization construct (e.g., instance 1162A-R) if implemented, and that part of the hardware 1140 that executes them (be it hardware dedicated to that execution and/or time slices of hardware temporally shared), forms a separate virtual electronic device 1160A-R.

A network interface (NI) may be physical or virtual. In the context of IP, an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). The NI is shown as network interface card (NIC) 1144. The physical network interface 1146 may include one or more antenna of the electronic device 1102. An antenna port may or may not correspond to a physical antenna. The antenna comprises one or more radio interfaces.

### A Wireless Network Per Some Embodiments

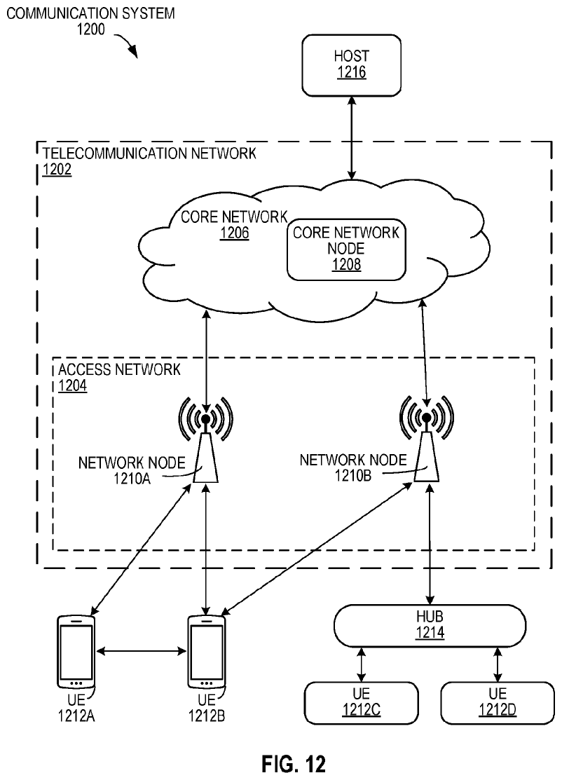

FIG. 12 illustrates an example of a communication system 1200 in accordance with some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3rd Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202 and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

### UE Per Some Embodiments

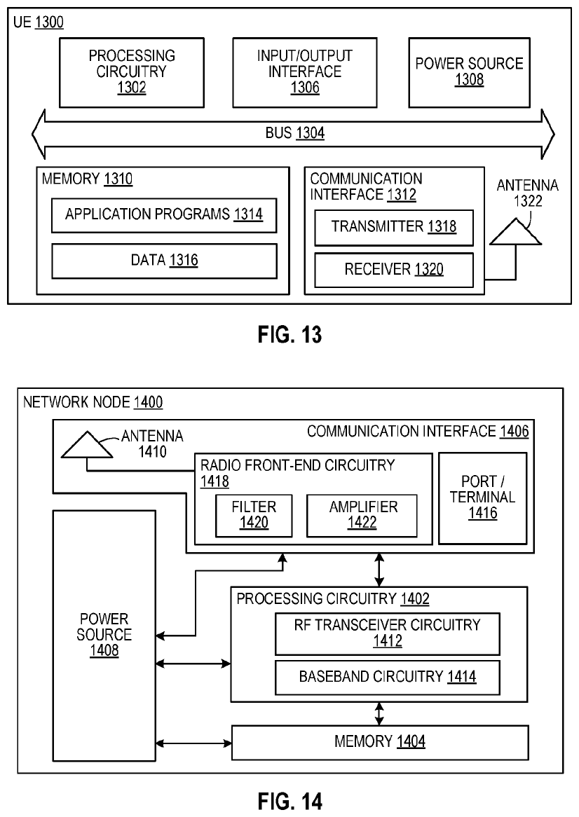

FIG. 13 illustrates a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random-access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

### Network Node Per Some Embodiments

FIG. 14 illustrates a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment.

Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

### Host Per Some Embodiments

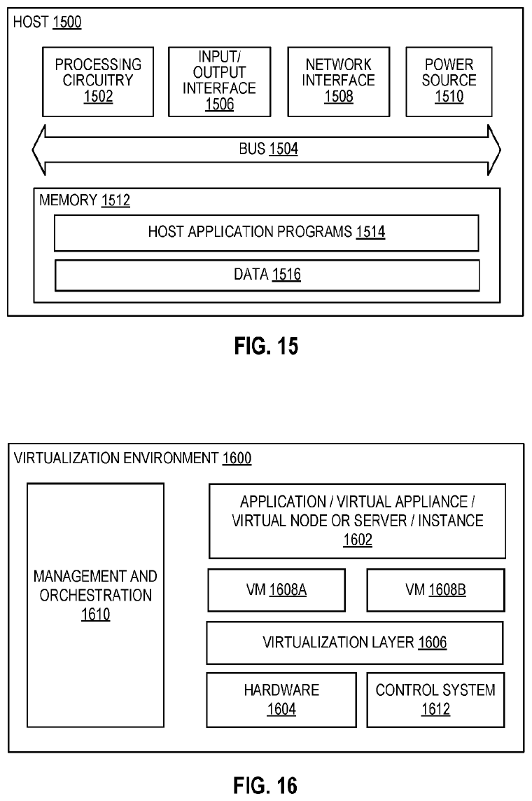

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

### Virtualization Environment Per Some Embodiments

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

### Communication Among Host, Network Node, and UE Per Some Embodiments

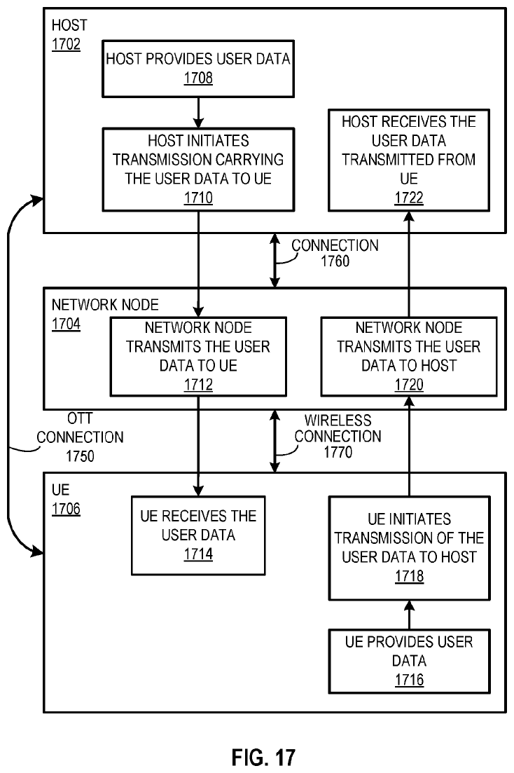

FIG. 17 illustrates a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Terms

An electronic device, such as electronic device 1102 and one of the computing devices discussed herein, stores and transmits (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals-such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

The terms “module,” “logic,” and “unit” used in the present application, may refer to a circuit for performing the function specified. In some embodiments, the function specified may be performed by a circuit in combination with software such as by software executed by a general-purpose processor.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method to be implemented in an electronic device to select features for performance prediction of an application in a network, comprising:
receiving a request to select one or more features to predict a performance issue of the application, the request indicating a set of key performance indicators (KPIs) for the application to indicate the performance issue of the application and data of performance metrics collected from the network;
selecting a first set of features from a plurality of features in response to the request, a feature from the plurality of features being selected to be included in the first set of features based on correlation between the feature and the set of KPIs;
selecting a second set of features from the first set of features to predict the performance issue of the application, a feature from the first set of features being selected to be included in the second set of features based on a causal relationship between the feature and the set of KPIs; and
causing prediction of the performance issue of the application based on the second set of features and corresponding time lags between the second set of features and the set of KPIs, wherein a time lag of a feature in the second set of features indicates a delay period between a change of the feature and impact of the change of the feature on a KPI within the set of KPIs.

2. The method of claim 1, wherein a weighted sum of corresponding correlation and historical correlation between the feature included in the second set of features and the set of KPIs is saved in a knowledge base for the feature.

3. The method of claim 1, wherein a first feature is selected from the first feature and a second feature within the plurality of features to be included in the first set of features while the second feature is eliminated based on correlation between the first and second features.

4. The method of claim 1, wherein the feature is selected from the plurality of features to be included in the first set of features based on comparing a threshold and a correlation score that indicates the correlation between the feature and the set of KPIs.

5. The method of claim 1, wherein the request additionally indicates one or more input parameters on which the selection of the first and second sets of features is based, including a type of the network, a type of application performance issue to be predicted through the set of features, and a set of resource constraints to perform the feature selection, and a set of feature selection parameters to indicate a selection scope.

6. The method of claim 5, wherein the plurality of features are stored in a knowledge base based on one or more types of networks and types of application performance issues related to the features.

7. The method of claim 5, wherein the set of feature selection parameters includes one or more of a maximum number of features to be selected for the request, a correlation threshold to select the first set of features for the set of KPIs, a correlation threshold to eliminate redundant features from the first set of features.

8. The method of claim 7, further comprising:
querying (1008) a knowledge base to select one or more features from the knowledge base to be included in the second set of features when the one or more features correlate to the set of KPIs over the correlation threshold.

9. (canceled)

10. The method of claim 1, wherein upon detecting the second set of features no longer predict the performance issue of the application accurately, initiating a reselection request to select one or more features to predict the performance issue of the application, and wherein the reselection request causes updating the second set of features.

11. An electronic device, comprising:
a processor and machine-readable storage medium that provides instructions that, when executed by the processor, are capable of causing the processor to perform:
receiving a request to select one or more features to predict a performance issue of an application, the request indicating a set of key performance indicators for the application to indicate the performance issue of the application and data of performance metrics collected from a network;
selecting a first set of features from a plurality of features in response to the request, a feature from the plurality of features being selected to be included in the first set of features based on correlation between the feature and the set of KPIs;
selecting a second set of features from the first set of features to predict the performance issue of the application, a feature from the first set of features being selected to be included in the second set of features based on a causal relationship between the feature and the set of KPIs; and
causing prediction of the performance issue of the application based on the second set of features and corresponding time lags between the second set of features and the set of KPIs, wherein a time lag of a feature in the second set of features indicates a delay period between a change of the feature and impact of the change of the feature on a KPI within the set of KPIs.

12. The electronic device of claim 11, wherein a weighted sum of corresponding correlation and historical correlation between the feature included in the second set of features and the set of KPIs is saved in a knowledge base for the feature.

13. The electronic device of claim 11, wherein a first feature is selected from the first feature and a second feature within the plurality of features to be included in the first set of features while the second feature is eliminated based on correlation between the first and second features.

14. The electronic device of claim 11, wherein the feature is selected from the plurality of features to be included in the first set of features based on comparing a threshold and a correlation score that indicates the correlation between the feature and the set of KPIs.

15. The electronic device of claim 11, wherein the request additionally indicates one or more input parameters on which the selection of the first and second sets of features is based, including a type of the network, a type of application performance issue to be predicted through the set of features, and a set of resource constraints to perform the feature selection, and a set of feature selection parameters to indicate a selection scope.

16. The electronic device of claim 15, wherein the plurality of features are stored in a knowledge base based on one or more types of networks and types of application performance issues related to the features.

17. The electronic device of claim 15, wherein the set of feature selection parameters includes one or more of a maximum number of features to be selected for the request, a correlation threshold to select the first set of features for the set of KPIs, a correlation threshold to eliminate redundant features from the first set of features.

18. The electronic device of claim 17, wherein the instructions, when executed by the processor, are capable of causing the processor to further perform:
querying a knowledge base to select one or more features from the knowledge base to be included in the second set of features when the one or more features correlate to the set of KPIs over the correlation threshold.

19. The electronic device of claim 17, wherein values of the set of feature selection parameters are obtained through training using a known performance issue of the application, sets of key performance indicators for the application to indicate the known performance issue of the application and data of performance metrics collected from the network.

20. The electronic device of claim 11, the processor being caused to further perform: upon detecting the second set of features no longer predict the performance issue of the application accurately, initiating a reselection request to select one or more features to predict the performance issue of the application, and wherein the reselection request causes updating the second set of features.

21. A non-transitory machine-readable storage medium that provides instructions that, when executed by a processor, are capable of causing the processor to perform:
receiving a request to select one or more features to predict a performance issue of an application, the request indicating a set of key performance indicators for the application to indicate the performance issue of the application and data of performance metrics collected from a network;
selecting a first set of features from a plurality of features in response to the request, a feature from the plurality of features being selected to be included in the first set of features based on correlation between the feature and the set of KPIs;
selecting a second set of features from the first set of features to predict the performance issue of the application, a feature from the first set of features being selected to be included in the second set of features based on a causal relationship between the feature and the set of KPIs; and
causing prediction of the performance issue of the application based on the second set of features and corresponding time lags between the second set of features and the set of KPIs, wherein a time lag of a feature in the second set of features indicates a delay period between a change of the feature and impact of the change of the feature on a KPI within the set of KPIs.

22. (canceled)
